(19) United States
(12) Patent Application Publication
(10) Pub. No.: US 2012/0000679 A1
(43) Pub. Date: Jan. 5, 2012

(54) FIRE EXTINGUISHER STRUCTURE

(76) Inventor: CHI-LUNG CHOU, TAINAN CITY (TW)

(21) Appl. No.: 12/827,055

(22) Filed: Jun. 30, 2010

(51) Int. Cl. A62C 11/00

(52) U.S. Cl. 169/30

(57) ABSTRACT

This invention relates to a fire extinguisher structure in which a bottle mouth is extended upward on the top end of the bottle body, a socket being provided on the bottom of a nozzle, an inner and an outer thread segments engaging with each other being respectively formed on the socket of the nozzle and the bottle mouth of the bottle body, a plug being extended from the center of the socket of the nozzle for blocking the aperture of the bottle mouth and being in transitional fitting therewith, a leak-proof ring being put over the plug of the nozzle for abutting against the end face of the bottle mouth. In this manner, leakage of high pressure gas contained within the fire extinguisher can be effectively avoided by the plug blocking the bottle mouth, the leak-proof ring and the socket.

### BACKGROUND OF THE INVENTION

1. Field of Invention

This invention relates to a fire extinguisher structure, especially to a novel fire extinguisher technology having multi-leakproof means enabling effective prevention of high pressure gas leakage from fire extinguisher.

2. Brief Description of the Prior Art

Fire accident is a terrible disaster, the devastation and destruction power of which often causes innocent people die-away and innumerable properties disappeared in the disaster. Although fire disaster is unpredictable, enlargement of fire disaster condition can be avoided if appropriate emergency measures can be taken in the beginning of fire. In this respect, fire extinguisher is just an indispensable means for restraining fire from enlarging. A number of fire extinguishers placed on noticeable sites can be employed to quench fire source unhurriedly at the first instance of fire, so as to achieve best fire fighting benefit.

The compositions of fire-extinguishing agent contained in the fire extinguisher has to be changed according to the producing mode of fire source, e.g., inflammables such as wood, fabric, oil should use fire-extinguishing agent containing foam compositions so that foam will float on the items on fire to insulate fire from the surface thereof so as to restrain fire from enlarging. While the fire resulting from solvent, oil should use fire-extinguishing agent containing powder by which the heat energy of fire is absorbed by the powder so as to mitigate fire spreading. Additionally, carbon dioxide (CO2) fire-extinguishing agent can push air out so that fire will die out due to absence of oxygen. As CO2 gas will not remain in place, it is suitable to be used in electrical appliances so as to avoid damage of apparatus. In order to enhance fire fighting effect of fire extinguishing agent, high pressure gas is usually charged into the fire extinguisher so that the fire-extinguishing agent can be easily ejected out from the fire extinguisher to quench the fire effectively. Therefore, the lifetime of a fire extinguisher is decided not only by the state being of the fire extinguishing agent itself but also by the status of high pressure gas kept within the bottle body of the fire extinguisher.

Referring to FIG. 5, a portable and simple type fire extinguisher of prior art is shown, which can be carried with one's person or disposed in car, and which can be readily acquired in the happening of accidental fire and is easily operable to quench the fire promptly. This fire extinguisher essentially has an inner thread segment (32) formed on the inner wall of bottle mouth (31) of its bottle body (3), and an outer thread segment (41) is extended from the bottom end of a nozzle (4) of the fire extinguisher to be in thread engagement with the inner thread segment (32) provided on the bottle body (3) so that the bottle body (3) of the fire extinguisher can be assembled integrally with the nozzle (4).

Assembly between the bottle body (3) and the nozzle (4) can be easily and securely accomplished by thread engagement. However, in order to achieve smooth thread engagement between the inner thread segment and the outer thread engagement, residual gap is usually provided between engaging threads in ordinary thread structure. The formation of residual gap will not result in improper effect to the combination or assembly for ordinary elements, but it is the main reason of gradual leakage of high pressure gas and hence shrinkage of lifetime of the fire extinguisher, especially in the case of conventional fire extinguisher the inner thread segment (32) is formed on the bottle body (3) and the outer thread segment (41) on the nozzle (4). Ordinarily, the fire extinguisher is normally placed with the nozzle (4) on the top side and bottle body under so that the high pressure gas contained in the bottle body is liable to flow upward along the residual gap existed between the threads to leak directly to the ambience. Hence, when fire happens, the fire extinguisher is unable to eject the fire extinguishing agents due to gradual leak-out of high pressure gas inside the bottle, so that fire fighting function cannot be enforced. Hence, in order to maintain fire fighting capability of fire extinguisher, the fire extinguisher should be replaced after a certain period of time, i.e., this means to place additional economical burden on user's shoulder. Moreover, as people nowadays are too busy to replace fire extinguisher in certain period of time, it often happens that fire extinguisher can not function very well in emergency. Therefore, how to mitigate and prevent the high pressure gas from leaking so as to prolong the lifetime of fire extinguisher is a critical issue in the manufacturing of the same.

In view of the disadvantages of high pressure gas leakage happened in conventional fire extinguisher, the inventor of this invention hereby proposes a novel fire extinguisher structure after endless endeavor with an intension to improve and upgrade the conventional fire extinguisher based on his abundant knowledge and experience in product development and manufacturing, so as to achieve better performance in practical application.

### SUMMARY OF THE INVENTION

This invention relates to a fire extinguisher structure, the main object of which is to provide a fire extinguisher technology capable of effectively preventing the high pressure gas from leaking out of fire extinguisher.

In order to achieve above object, the inventor of the present invention proposes a fire extinguisher structure, which essentially comprises a bottle body and a nozzle, a bottle mouth being extended upward from the top end of the bottle body, a socket being provided on the bottom of a nozzle, an inner and an outer thread segments engaging with each other being respectively formed on the socket of the nozzle and the bottle mouth, a plug being extended from the center of the socket of the nozzle for blocking the aperture of the bottle mouth and being in transitional fitting therewith, a leak-proof ring being put over the plug of the nozzle for abutting against the end face of the bottle mouth.

In this manner, leakage of high pressure gas contained within the fire extinguisher can be effectively avoided by the multiple provisions including: the plug blocking the bottle mouth, the leak-proof ring abutting the end face of bottle mouth and the socket in thread engagement on the bottle mouth. Moreover, the lifetime of fire extinguisher can be remarkably prolonged so that fire fighting effect can be maintained over a long period of time so as to lessen economical burden of replacing fire extinguisher in every certain period of time.

### BRIEF DESCRIPTION OF THE DRAWINGS

FIG. 1 is a perspective exploded view showing the fire extinguisher of the present invention.

FIG. 2 is a perspective view showing the fire extinguisher of the present invention.

FIG. 3 is a sectional view showing the fire extinguisher of the present invention.

FIG. 4 is a partially sectional view showing the fire extinguisher of the present invention.

FIG. 5 is a perspective exploded view of a prior art.

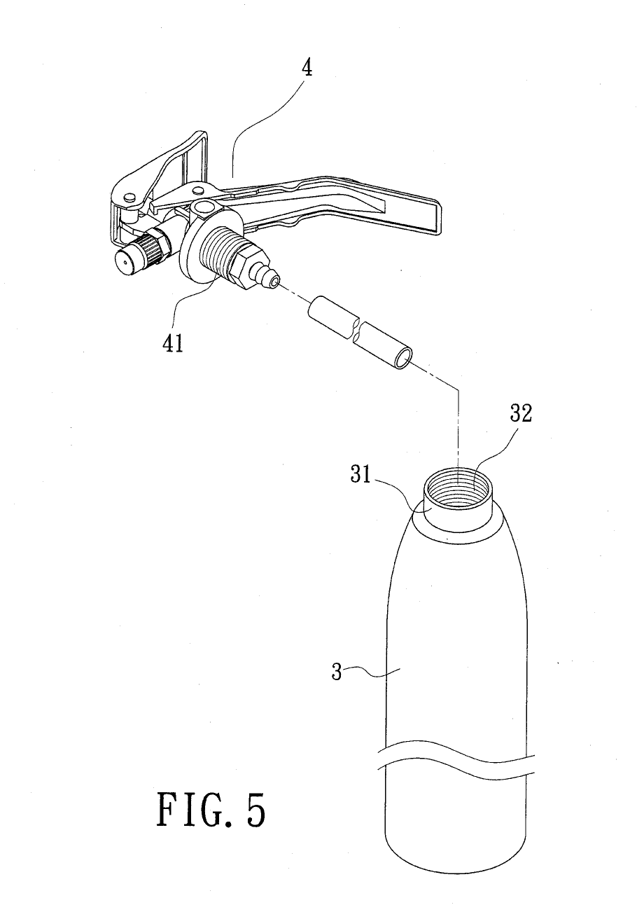

### DETAILED DESCRIPTION OF PREFERRED EMBODIMENTS

The objects, the technical contents and the expected effect of the present invention will become more apparent from the detailed description of the preferred embodiments in conjunction with the accompanying drawings.

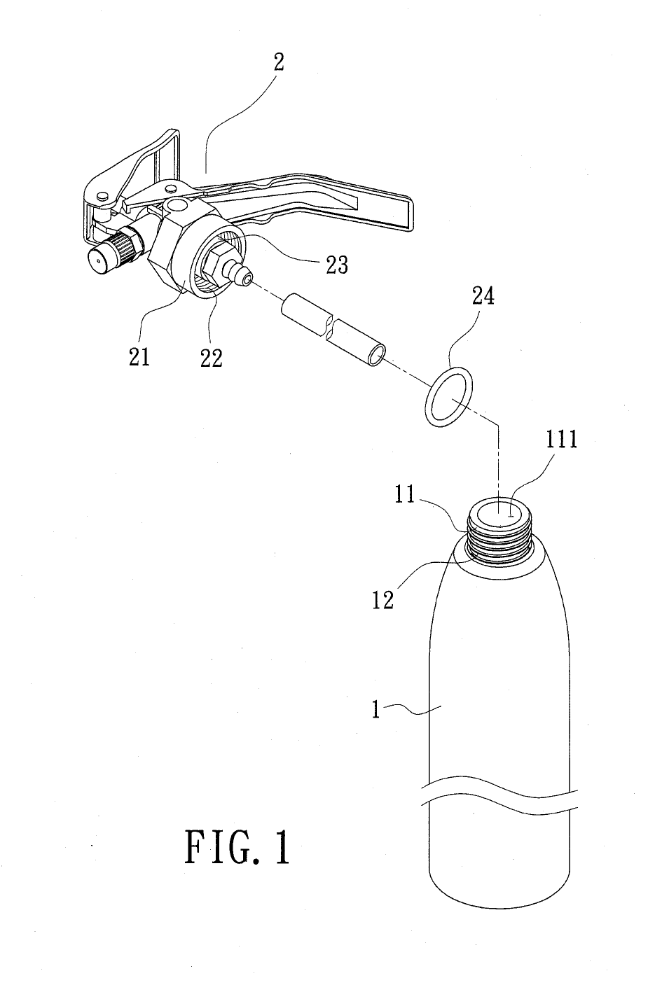

Firstly, referring to FIG. 1, the extinguisher structure of the present invention essentially comprises a bottle body (1) and a nozzle (2), a bottle mouth (11) being extended from the top end of the bottle body (1), an outer thread segment (12) being formed on the outer wall of the extending bottle mouth (11). A socket (21) is provided integrally on the bottom of the nozzle (2) and an inner thread segment (22) is formed on the inner wall of the socket (21) for engaging with the outer thread segment (12) provided on the bottle mouth (11) of the bottle body (1). A plug (23) is extended from the center of the socket (21) for blocking the aperture (111) of the bottle mouth (11) and is in transitional fitting therewith. A leak-proof ring (24) is put over the plug (23) for abutting against the end face of the bottle mouth (11).

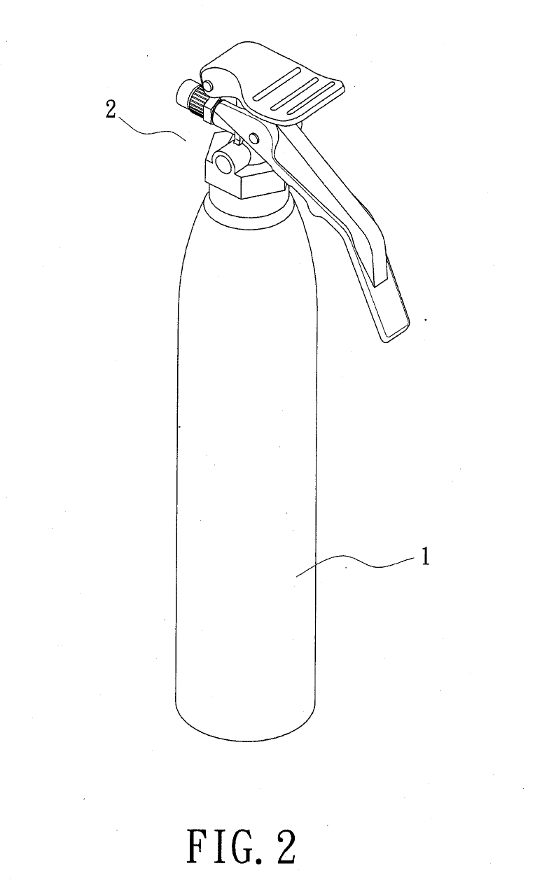

With this structure, as shown in FIGS. 1 and 2, firstly the plug (23) extended from the center of the socket (21) correspondently blocks the aperture (111) of the bottle mouth (11) of the bottle body (1) in assembly process. Then, the socket (21) of the nozzle (2) can be put over the bottle mouth (11).

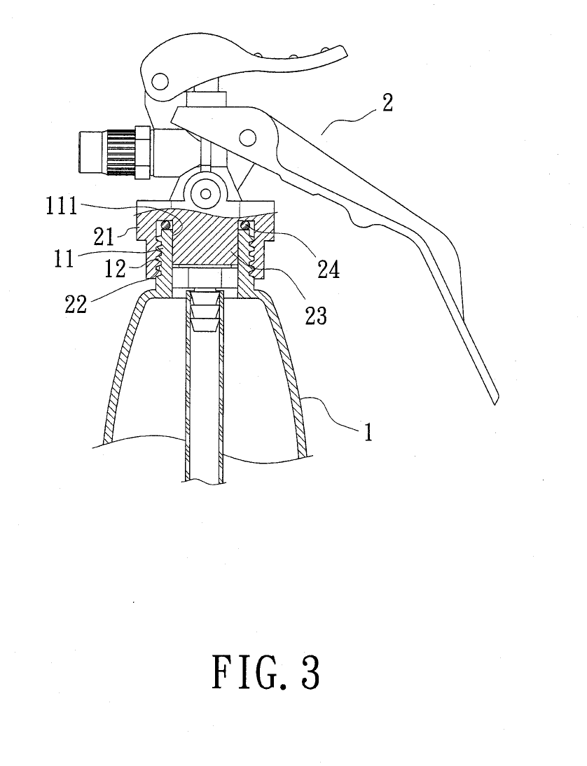

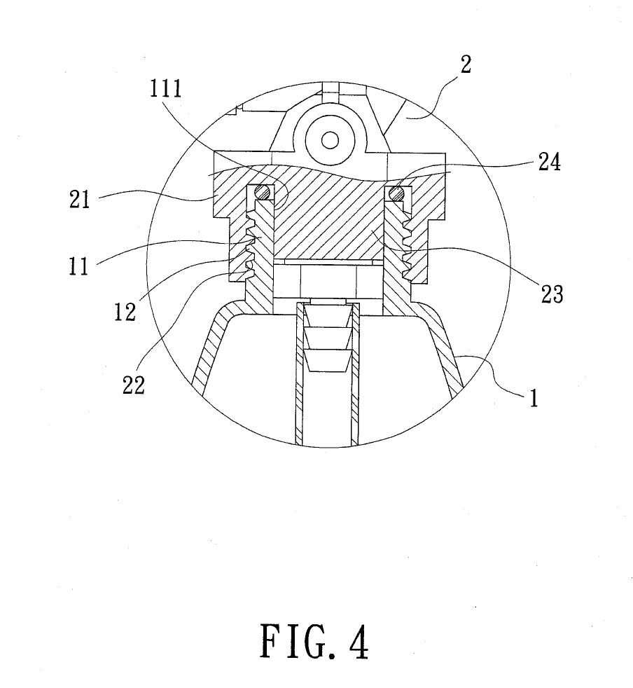

In turn, as shown in FIG. 3, the nozzle (2) is rotated to allow the inner thread segment (22) of the socket (21) engages with the outer thread segment (12) formed on the outer wall of the bottle mouth (11). The tighter the engagement between the inner and the outer thread segments (22), (12) of the socket (21) and the bottle mouth (11) is, the deeper the plug (23) of the nozzle (2) entering the aperture (111) of the bottle mouth (11) becomes. Once the engagement between the inner and the outer thread segments (22), (12) of the socket (21) and the bottle mouth (11) comes to end, the plug (23) of the nozzle (2) completely blocks into the aperture (111) of the bottle mouth (11) and the leak-proof ring (24) put over the plug (23) is simultaneously abutted against the end face of the bottle mouth (11), as shown in FIG. 4.

In this way, the plug (23) blocking the aperture (111) of the bottle mouth (11) of the bottle body (1) and in transitional fitting therewith is served as the first means for preventing the high pressure gas charged into the inside of the bottle body (1) from leaking out.

If the high pressure gas is carelessly leaked out from between the plug (23) and the aperture (111) of the bottle mouth (11) to the end face thereof, it can be blocked by the leak-proof ring (24) to avoid leakage therefrom. Therefore, the leak-proof ring (24) is served as the second means for preventing the high pressure gas from leaking.

Subsequently, if the high pressure gas is still carelessly leaked out from the leak-proof ring (24), it can be stopped by the socket (21) of the nozzle (2) put over the bottle mouth (11) of the bottle body (1) so that the socket (21) is served as the third means for preventing the high pressure gas from leaking out. As the high pressure gas flows upward from the aperture (111) of the bottle mouth (11), it is impossible to change its flow direction to flow downward to the bottom end face to leak out even if it flows to the leak-proof ring (24). Therefore, leakage of high pressure gas contained within the fire extinguisher can be effectively avoided by the design of this three leak-proof means. Moreover, the lifetime of fire extinguisher can be remarkably prolonged so that fire fighting effect can be maintained over a long period of time so as to lessen economical burden of replacing fire extinguisher in every certain period of time.

It is apparent from the above structure and implementation, the present invention has the following advantages.

1. The fire extinguisher of the present invention is essentially provided with a socket integrally formed on the bottom of the nozzle to fit over the bottle mouth of the bottle body, and a plug extends out from the center of the socket and is in transitional fitting with the bottle mouth of the bottle body so as to block the aperture thereof. Accordingly, this is served as the first means for preventing the high pressure gas from leaking out.

2. The fire extinguisher of the present invention has a leak-proof ring put over the plug of the nozzle to abut against the end face of the bottle body, so as to serve as the second measure for preventing high pressure gas from leaking out.

3. The fire extinguisher of the present invention utilizes the socket covered the aperture of the bottle mouth of the bottle body as the third measure for preventing high pressure gas from leaking out. Hence, the high pressure gas flowing upward is blocked by the socket and is impossible to flow out from reverse direction.

4. The fire extinguisher of the present invention can effectively avoid leakage of high pressure gas contained within the fire extinguisher by the above three leak-proof means. Moreover, the lifetime of fire extinguisher can be remarkably prolonged so that fire fighting effect can be maintained over a long period of time so as to lessen economical burden of replacing fire extinguisher in every certain period of time.

What is claimed is:

1. A fire extinguisher structure, essentially comprising a bottle body and a nozzle, a bottle mouth being extended from the top end of the bottle body, a socket being provided on the bottom of a nozzle, an inner and an outer thread segments engaging with each other being respectively formed on the socket and the bottle mouth of the bottle body, a plug being extended from the center of the socket for blocking the aperture of the bottle mouth and being in transitional fitting therewith, a leak-proof ring being put over the plug of the nozzle for abutting against the end face of the bottle mouth.

2. The fire extinguisher structure as claimed in claim 1, wherein said socket is formed integrally with the nozzle.
